(19) United States
(12) Patent Application Publication
(10) Pub. No.: US 2019/0279279 A1
(43) Pub. Date: Sep. 12, 2019

(54) SYSTEMS AND METHODS FOR IDENTIFYING AND HIRING SERVICE PROVIDERS

(71) Applicant: Nishant Tomar, Crystal Lake, IL (US)

(72) Inventor: Nishant Tomar, Crystal Lake, IL (US)

(21) Appl. No.: 16/276,207

(22) Filed: Feb. 14, 2019

Related U.S. Application Data
(60) Provisional application No. 62/630,009, filed on Feb. 13, 2018.

(51) Int. Cl. G06Q 30/06

(52) U.S. Cl. CPC G06Q 30/0639; G06Q 30/0633

(57) ABSTRACT

Systems and methods for identifying and hiring service providers allows users to search for specialized on-demand service providers, often for emergent needs. More specifically, present invention allows users having on-demand service needs to search for and identify service providers in their locale that are available immediately to provide services depending on the user's needs, or to set up an appointment for later service. The present invention further allows for easy and efficient measuring of time required to complete a service and automatic generation of an invoice based on the time tracked and other inputs, which can be paid by the user directly.

The present invention claims priority under 35 U.S.C. 119(e) to U.S. Provisional Pat. App. No. 62/630,009, titled “Systems and Methods for Identifying and Hiring Service Providers,” filed Feb. 13, 2018, which is incorporated herein by reference in its entirety.

### TECHNICAL FIELD

The present invention relates to systems and methods for identifying and hiring service providers. Specifically the present invention allows users to search for specialized on-demand service providers, often for emergent needs. More specifically, present invention allows users having on-demand service needs to search for and identify service providers in their locale that are available immediately to provide services depending on the user's needs, or to set up an appointment for later service. The present invention further allows for easy and efficient measuring of time required to complete a service and automatic generation of an invoice based on the time tracked and other inputs, which can be paid by the user to the service providers directly and instantly

### BACKGROUND

It is, of course, generally known to utilize service providers at a home or business, depending on the needs of customers. Specifically, many service providers have specialized skills and offer their skills as services for hire by individuals with need of those skills. For example, certain specialized service providers include handyman services, moving services, lawn and garden services, snow removal services, cook/chef services, and other like services. However, service providers may also provide their skills free of charge as volunteers for events, for charities, or for other like reasons.

It is, however, often difficult to identify service providers and their particular skill set when one is needed. Oftentimes, when a service provider is needed, one must access a printed guide, such as the Yellow Pages, or as more commonly done today, find a service provider using an internet search. However, with a printed guide or even with the Internet, it is often difficult to obtain specific information that may be useful in deciding whether to hire a service provider, such as rate information, location information, specialized skills, or other like information. The difficulties in obtaining service providers for particular services can continue even after a service provider is identified. Specifically, a person who needs a service provider often has difficulty contacting a service provider, setting up appointments, and discussing services needed. Often, services are needed on an emergency basis, and it is often difficult to simply identify a service provider that may be available to provide his or her services.

First, it is often difficult to reach a service provider. Many are small business concerns and have limited staff for receiving messages. Oftentimes, messages must be left on machines or in voicemail in the hopes that the service provider calls an individual back. And when a service provider is accessible, it is often difficult to get on the service provider's schedule.

This may be particularly important in the case of emergent situations. Specifically, service providers are often needed due to emergencies, especially when equipment breaks down or damage occurs to a building. For example, in the case of a frozen or clogged pipe, a plumber is often necessary right away to fix the problem. Without availability by service providers, customers may spend inordinate amounts of time simply tracking down a service provider that can help them with their service needs.

In addition, once a service provider is hired, it is further difficult to obtain an accurate gauge as to the amount of time that is spent on a project. Typically, service providers charge rates that are hourly or some increment of hourly. Therefore, the final cost is dependent on the amount of time spent on the project. As such, accurate tracking of time is required by both the service provider and the customer. More specifically, customers often have difficult verifying the amount of time that service providers spend on projects, and must often rely on the service provide himself or herself keeping an accurate measure of time. The customer may be or feel cheated by a service provider if the customer believes that the service provider is not accurately reporting time spent on the project. And from the service provider's perspective when time is tracked accurately, this can still lead to unjustified accusations that are difficult to defend.

Further, it can be difficult for service providers to obtain payment from customers on an expeditious basis. Oftentimes, invoices are sent to client based on services performed, and service providers must spend large amounts of time chasing payment from customers.

A need, therefore, exists for improved systems and methods of identifying available service providers. More specifically, a need exists for improved systems and methods of obtaining service providers when needed by an individual.

Moreover, a need exists for improved systems and methods that provide instant availability information concerning service providers. In addition, a need exists for improved systems and methods that allow users to identify and request services instantaneously when needed.

Further, a need exists for improved systems and methods for tracking service providers once on a job at a home or business. Still further, a need exists for improved systems and methods for billing services provided by the service providers and collecting money from the individuals.

Moreover, individuals may have skills that may be useful and may wish to provide services to earn additional income, but may not wish to work full-time as a service provider. For example, individuals may have a job or career in an unrelated field, and may wish to provide services on the side based on his or her skillset. In addition, businesses may have workers that have skillsets that could be useful, and may wish to hire these workers out as service providers, such as maintenance workers and the like. For these people, setting up and running a full-time business is not desirable based on their availability.

A need, therefore, exists for improved systems and methods that allow service providers the flexibility to work when they want. Specifically, a need exists for improved systems and methods that allow service providers to instantly inform potential customers whether and/or when they are available for providing services.

### SUMMARY OF THE INVENTION

The present invention relates to systems and methods for identifying and hiring service providers. Specifically the present invention allows users to search for specialized on-demand service providers, often for emergent needs. More specifically, present invention allows users having on-demand service needs to search for and identify service providers in their locale that are available immediately to provide services depending on the user's needs, or to set up an appointment for later service. The present invention further allows for easy and efficient measuring of time required to complete a service and automatic generation of an invoice based on the time tracked and other inputs, which can be paid by the user directly.

To this end, in an embodiment of the present invention, a method of offering services by a service provider and obtaining services by a customer of a service provider is provided. The method comprises the steps of: providing a module resident on a server and accessible by a plurality of service providers via service provider computing devices and a plurality of customers via customer computing devices; accessing the module by the service providers, each inputting information concerning one or more services offered by the service providers; accessing the module by a customer and requesting a particular service offered by the service providers; displaying a map on the customer's computing device showing location information of one or more service providers offering the service selected by the customer, wherein each service provider offering the particular service requested by the customer is displayed on the map via an icon, wherein each icon is coded based on whether the service provider is available to accept a service request or is unavailable to accept a service request; and selecting one of the service providers by selecting one of the icons on the map and sending a request for service to the computing device of the selected service provider.

It is, therefore, an advantage and objective of the present invention to provide improved systems and methods of identifying available service providers.

More specifically, it is an advantage and objective of the present invention to provide improved systems and methods of obtaining service providers when needed by an individual.

Moreover, it is an advantage and objective of the present invention to provide improved systems and methods that provide instant availability information concerning service providers.

In addition, it is an advantage and objective to provide improved systems and methods that allow users to identify and request services instantaneously when needed.

Further, it is an advantage and objective of the present invention to provide improved systems and methods for tracking service providers once on a job at a home or business.

Still further, it is an advantage and objective of the present invention to provide improved systems and methods for billing services provided by the service providers and collecting money from the individuals.

In addition, it is an advantage and objective of the present invention to provide improved systems and methods that allow service providers the flexibility to work when they want.

Specifically, it is an advantage and objective of the present invention to provide improved systems and methods that allow service providers to instantly inform potential customers whether and/or when they are available for providing services.

Additional features and advantages of the present invention are described in, and will be apparent from, the detailed description of the presently preferred embodiments and from the drawings.

### BRIEF DESCRIPTION OF THE DRAWINGS

The drawing FIGURES depict one or more implementations in accord with the present concepts, by way of example only, not by way of limitations. In the FIGURES, like reference numerals refer to the same or similar elements.

FIG. 1 illustrates a system and method representation showing service provider and customer access thereof in an embodiment of the present invention.

### DETAILED DESCRIPTION OF THE PRESENTLY PREFERRED EMBODIMENTS

The present invention relates to systems and methods for identifying and hiring service providers. Specifically the present invention allows users to search for specialized on-demand service providers, often for emergent needs. More specifically, present invention allows users having on-demand service needs to search for and identify service providers in their locale that are available immediately to provide services depending on the user's needs, or to set up an appointment for later service. The present invention further allows for easy and efficient measuring of time required to complete a service and automatic generation of an invoice based on the time tracked and other inputs, which can be paid by the user directly.

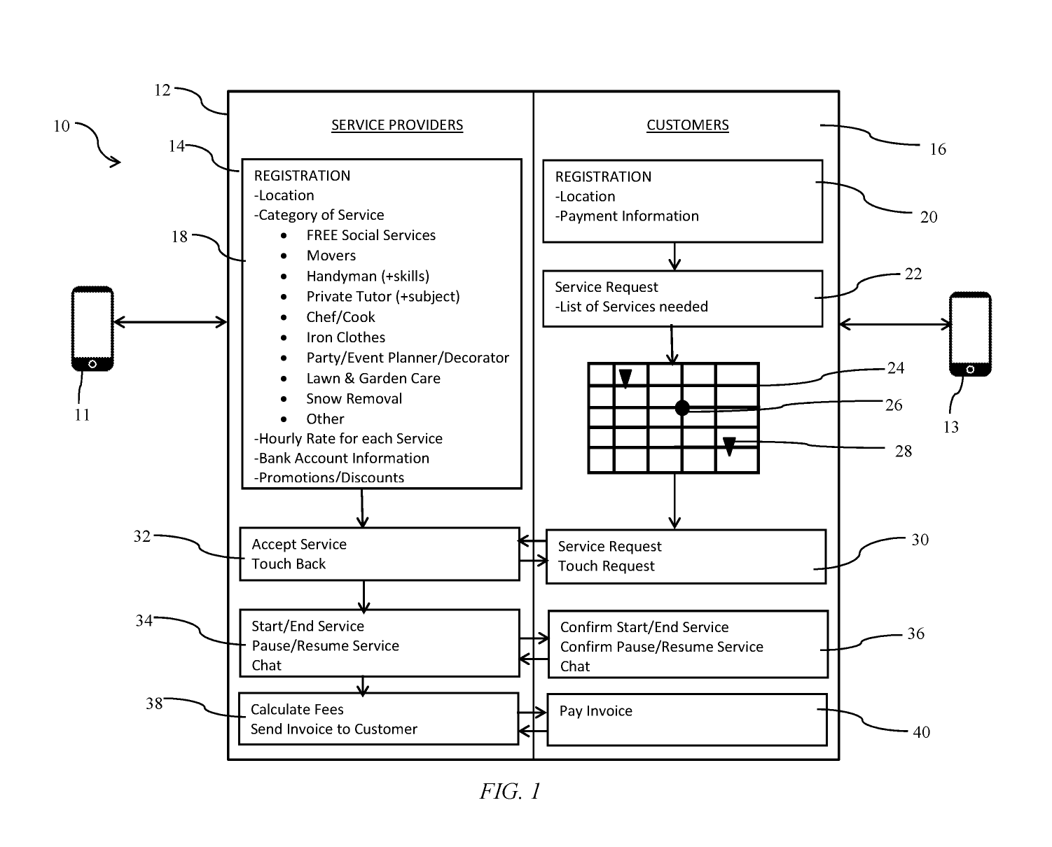

FIG. 1 illustrates a system 10 in an embodiment of the present invention. The system 10 comprises a module 12 having accessibility by a plurality of service providers and a plurality of customers, each of who may wish to utilize the app for the purposes described herein. The system 10 comprises a module or application 12 that may be resident on a server and accessible by one or more smart phones, tablet computers, laptop computers, desktop computers, or other like computing devices that may be utilized for this purpose, represented by service provider smart phone 11 and customer smart phone 13 on FIG. 1. Preferably, the module 12 may be accessible by a smart phone or tablet computer that is portable. Moreover, the module 12 of the present invention may be accessible via the Internet through portals that may be accessed via web browsers, or may be presented to users thereof in the form of an app through their computing devices 11, 13.

The system 10, illustrated in FIG. 1, shows module 12 having a service provider side 14 and a customer side 16 that may be accessible depending on whether the user is a service provider or a customer. Specifically, the service provider side 14 may be accessed via one or more computing devices 11 as noted above by one or more service providers that may wish to offer their services to customers. The customer side 16 may be accessed via one or more computing devices 13 as noted above by one or more customers that may wish to obtain the services of the one or more service providers.

Starting with the service provider side 14, one or more service providers may opt to join the system 10 to offer his or her services through the system 10 to one or more customers, as described in more detail below. Upon registration via step 18 by the service provider using his or her computing device 11, he or she may enter particular information concerning his account, including, for example, identification information, a password, and other like general information concerning himself or herself, and/or his or her business. In addition, particular information useful for the present invention include location information of his or her business, or of his or her smartphone or tablet computer, may be entered. For example, an option may be presented to the service provider to automatically obtain location information of the business location, his or her smartphone or tablet computer (identifying, therefore, immediate location information, assuming the smartphone or tablet computer travels with the service provider), or both. Alternatively, or in addition, the service provider may be provided an option to enter an address or other like location information into the system module 12. The location of the service provider may be done by location tracking information of the service provider's smartphone or tablet computer, or via location information based on IP address or the like.

Further information may be entered by the service provider, such as information concerning one or more categories of services that the service provider may offer to customers. For example, and as listed in FIG. 1, the categories of services may include social services, more particularly free social services, moving services, handyman services, private tutoring services, chef/cook services at the customers' homes, clothes ironing at the customers' homes, party/event planning/decorating, lawn and garden care services, snow removal services, or any other service that may be offered by a service provider that is not covered herein. In addition, in some categories specialties or “skills” may be selected or entered by the service provider to more specifically designate his or her skills and offerings. For example, if “handyman” is selected by the service provider, he or she may be presented with further options to specify skills, such as “electrician,” “plumber,” “carpenter,” or other specific skills.

More than one category of skill may be entered by a service provider, and further more than one particular skill may be entered for any category of service, if necessary. Thus, a service provider that may have several different skills or services available may be able to communicate that fact to customers, according to the present invention, and as detailed below.

Further information may be entered by the service providers, including rates for providing the service, whether flat fee or hourly rate, bank account information for accepting payments, and promotions/discounts that the service provider may wish to offer to customers for selecting them. Of course, any other information may be entered by a service provider as necessary to communicate effectively his or her services and/or skill sets to potential customers, and the present invention should not be limited as described herein.

With respect to promotions or discounts offered by service providers, the module 12 may allow a service provider to select or define a promotion/discount and store the same on the module 12, whether active or inactive. When a promotion/discount is created or selected by a service provider, he or she may opt to activate the promotion/discount to attempt to convince customers to hire them. If hired when the promotion/discount is active, the invoice generated by the module 12, as described below, may automatically reflect the active promotion/discount.

Turning now to the customer side 16 of the module 12, customers may opt to register to the module 12 via one or more customer computing devices 13 of the present invention via step 20 so that the customers can obtain immediate information concerning local service providers, their particular services and/or skills, their billing rates, and their availability, as described more fully below. Upon using the system 10, the customers may register themselves with the module 12 and enter basic information, such as identity information, passwords and other like information to set up an account. More pertinent to the present invention, information concerning their location may be provided. For example, the module 12 may inquire whether the customer wishes to obtain his or her location automatically (via location determination means of the customer computing devices 13, or whether the customers wish to enter information directly into the module 12, such as address information, concerning the customers' location, such as their home or business, via the customer computing devices 13.

Moreover, information concerning a payment method may also be requested and entered by the customer into the system 10, which may store the payment information with sufficient safeguards. For example, information on credit cards, PayPal, Apple Pay, or other like payment methods may be specified and automatically entered when a customer pays an invoice, as described below.

Once a customer registers his or her information into the module 12, the customer may be presented with an inquiry concerning the desired service needed by a service provider, via step 22. Specifically, the customer may be presented with a list of services offered by one or more service providers, as stored in the module 12. Specifically, the list of services offered to the customers may include social services, such as free social services, moving services, handyman services, private tutoring services, chef/cook services, clothes ironing services, party/event planning/decorating services, lawn and garden care services, snow removal services, and any other services offered. Moreover, if particular skills are needed, such as “electrical,” “plumbing,” “carpentry,” or any other skill, these may also be selected by the customer.

Once the particular service need is identified and selected by the customer, the customer may be presented with a map 24 showing all of the service providers in a defined area around the location of the customer 26 or another location entered by the customer. Preferably, by default, the customer's location as determined by the module 12 may be used (called “My Location”), or the customer may have the ability to put any other location information, which may be useful if a customer is attempting to find a service provider at a location different that the location registered. For example, once the service needs are identified, the map 24 may appear on the customer's computing device 13 showing all of the service providers found in the search via icons 28 for that service and/or skill within a 5-mile radius of the customer's location. If no service providers for the particular service needs are identified the predefined distance, then the map may automatically zoom out until at least one service provider is contained within the map. If a service provider is not found within a predefined maximum range, such as within 100 miles of the customer, than a notification may be provided to the customer that no such service provider can be found within that predefined distance. Also, the customer may be provided with the function of zooming out or in on the map as desired by clicking on buttons for that purpose, such as a “+” button to zoom in and a “−” button to zoom out.

If one or more service providers are shown on the map 24 and viewable by the customer on his or her computing device 13, each service provider may be represented by the icon 28, and each icon 28 may be further coded to indicate whether the service provider is available for hire, whether the service provider is unavailable for hire, or whether the service provider is busy at the moment but otherwise available for hire. For example, if the service provider identified on the map 24 is available for hire immediately, his or her icon 28 may be green. A service provider that is not available at all may have an icon 28 that is coded with a gray color. And a service provider that is busy but otherwise available for hire at a future time may have an icon 29 that is coded red. These visual icons therefore provide instant information to a customer as to their availability for hire.

The customer may elect to obtain further information concerning each service provider before deciding to hire, such as ratings information, rate information, whether flat fee or hourly, promotions/discounts offered, or any other information that may be desired by a customer and stored about the service provider. The customer may obtain such further information by selecting the service provider's icon 28. Further information about the service provider may be presented to the customer, such as by opening a window with the information thereon.

The customer may wish to hire the service provider, if available, by sending a “service request” via step 30 to the service provider when the customer clicks on the icon, for example. When a request for hire is selected by the customer, contact information, such as a phone number, or a real-time chat box may be opened on the customer's computing device that may offer real-time chat with the service provider so that the customer can relay information concerning the project to the service provider, to ask questions, or for any other purpose. The service provider may then accept the hire via step 32.

Alternatively, a customer may wish to inquire whether an unavailable or busy service provider (such as a service provider having an icon 28 colored gray or red) may be available at a future day or time, and so the customer may opt to “Touch” the service provider via step 30, which may send a message to the service provider that the customer wishes to engage the service provider in a future service. In the service provider wishes to open a dialog with the customer, the service provider may “Touch Back” via step 32. “Touch” and “Touch Back” are simply ways to ping a service provider and let them know that a potential customer has interest in hiring them, and gives the service provider the ability to contact them back to discuss in more detail, either by phone or via instant chat through the module 12.

Upon acceptance of a service request by a service provider, the module 12 may provide the location information of the customer and any other pertinent information concerning the customer and his or her location. Upon traveling to the location to perform the service, the service provider may select to “start service” via step 34, which may be communicated to the customer for confirmation thereof via step 36 so that the customer and the service provider are aligned about when service started. The customer may confirm the start of service by clicking a “Confirm” button that may appear on his or her computing device screen. This may be particular important if the service is based on an hourly rate, and the system 10 may thus track the amount of time the service provider spends on the service needed by the customer. Moreover, if the service provider pauses service, such as by taking breaks, lunch, attending to other matters, etc., the service provider may elect to “pause service” via step 34, and the pause in the service may be confirmed by the customer via step 36 by providing a “Confirm” button the customer computing device screen. This ensures that both the service provider and the customer are aligned and agree as to the amount of time worked by the service provider. Once finished, the service provider may elect to “end service” via step 34, which may be confirmed by the customer via step 36. If there are disagreements about when the service actually started, paused or ended, a chat feature may allow the customer and the service provider to discuss immediately to ward off any future billing problems.

Once the service is completed, an invoice may be generated via step 38 by the module 12, based on the rate information, the time spent on the service (if an hourly or time-based rate is charged), including materials purchased, or promotions/discounts given. Once the invoice is generated to the service provider's satisfaction and the service provider approves the invoice by clicking on an “Approve” button on the service provider's computing device 11, the invoice may be sent to the customer via the module 12, whereupon the customer may automatically pay the invoice via payment information stored on the module 12 via step 40 or via any other means apparent to one of ordinary skill in the art.

The system 10 of the present invention may have other functions and capabilities. For example, a service provider may be presented with options to track historical information about customers and/or services provided. Likewise, customers may also have stored information concerning historical data, such as information concerning service providers they had used in the past, rate information, and other like information. Moreover, if disputes arise, the system 10 may allow service providers to offer partial or full refunds.

Both service providers and customers may also be provided with options to rate each other, respectively. For example, a customer may be presented with the option to rate the service provider, but the service provider may also be presented with the ability to rate the customer. Therefore, if a customer is particularly difficult to work with, then a service provider may offer that assessment of the customer, which may be available to others. Therefore, while a customer can use ratings of service providers to decide to hire a service provider, a service provider may also use ratings of customers to decide whether to accept a service request from a customer.

Other particular information concerning specifics about the present invention is presented in Appendix A, which is incorporated herein. Specifically, Appendix A details other features of the system 10 and, specifically, the module 12, whether as an application accessible over the Internet, an app accessible through an app store, or the like. Other features may include acceptance by both service providers and customers of terms and conditions, license information, password editing, and other like features.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. A method of offering services by a service provider and obtaining services by a customer of a service provider comprising the steps of:
providing a module resident on a server and accessible by a plurality of service providers via service provider computing devices and a plurality of customers via customer computing devices;
accessing the module by the service providers, each inputting information concerning one or more services offered by the service providers;
accessing the module by a customer and requesting a particular service offered by the service providers;
displaying a map on the customer's computing device showing location information of one or more service providers offering the service selected by the customer, wherein each service provider offering the particular service requested by the customer is displayed on the map via an icon, wherein each icon is coded based on whether the service provider is available to accept a service request or is unavailable to accept a service request; and
selecting one of the service providers by selecting one of the icons on the map and sending a request for service to the computing device of the selected service provider.
